(19) United States
(12) Patent Application Publication
(10) Pub. No.: US 2025/0365233 A1
(43) Pub. Date: Nov. 27, 2025

(54) DYNAMIC LOAD BALANCING WITH IMPROVED RSS

(71) Applicant: MICROSOFT TECHNOLOGY LICENSING, LLC, Redmond, WA (US)

(72) Inventor: Gaurav BANSAL, Bengaluru (IN)

(21) Appl. No.: 18/674,557

(22) Filed: May 24, 2024

(51) Int. Cl. H04L 47/125; H04L 47/193

(52) U.S. Cl. CPC H04L 47/125; H04L 47/193

(57) ABSTRACT

Network traffic management is performed in a system comprising a network interface card (NIC) operatively coupled to a processor with multiple cores. The NIC is configured to execute receiver side scaling (RSS). The NIC generates a hash table for tracking communications flows that have been assigned to selected cores of the multiple cores. In response to receiving, at the NIC, a packet associated with a new communication flow, the NIC accesses a flag indicating that a first core of the multiple cores exceeds a threshold for CPU utilization. In response to determining that the flag indicates that the first core of the multiple cores exceeds the threshold for CPU utilization, the first core of the multiple cores is excluded from an RSS function for load balancing the multiple cores. A subset of the multiple cores that exclude the first core is used for load balancing the multiple cores.

### BACKGROUND

Remote or cloud computing typically utilizes a collection of remote servers in datacenters to provide computing, data storage, electronic communications, or other cloud services. The remote servers can be interconnected by computer networks to form one or more computing clusters. During operation, multiple remote servers or computing clusters can cooperate to provide a distributed computing environment that facilitates execution of user applications to provide cloud services. With the advent of increasingly advanced network technologies (e.g., 5G networks, 6G networks) there is a corresponding increase in the demand for enhanced user experiences such as increased bandwidth, reduced latency, and improved reliability. One of the various ways that are used to achieve this objective is load balancing. Load balancing is commonly used in networking to ensure that the incoming traffic is distributed across various networking and processing resources so that no single resource is overutilized and causes a choke point. For example, incoming traffic can be distributed across a pool of servers using several load balancing strategies such round robin, least loaded server, and the like. Further, global server load balancing (GSLB) can be used to distribute traffic across multiple data centers or geographical locations.

It is with respect to these and other considerations that the disclosure made herein is presented.

### SUMMARY

One challenge for improving throughput to software components on a server is to overcome limited processing capacities of the cores. During operation, executing network processing operations can overload the cores and thus the cores can become communications bottlenecks. As the incoming traffic rate increases, a single core can become inadequate for executing network processing operations. As such, processing capabilities of the cores can limit transmission rates of data to/from software components on the server.

Load balancing can be used in several forms to ensure that incoming traffic is processed efficiently. Distributing traffic among a pool of servers is one way to implement load balancing. Another way is to introduce load balancing at the NIC level which can be implemented by means of Receive Side Scaling (RSS).

With current RSS implementations, it is possible for the NIC to send packets to a queue for a core that is saturated (i.e., the central processing unit (CPU) cores are fully utilized with no more additional processing capacity available) while under-saturated cores (i.e., CPUs which are not fully utilized) are still available. This can lead to performance issues with the possibility of packet drops, even if the packets could have been processed by the under-utilized cores. The present disclosure provides a way to reduce this impact by improving RSS techniques to avoid over-saturation of cores. In various embodiments, a hash table is implemented in the NIC which takes into account the current load on the various cores. In one embodiment, a new flag is introduced in the RSS configuration parameters. One example of a flag can be REDUCE-INCOMING-TRAFFIC-RATE. If the usage of a particular CPU core exceeds a predetermined threshold, the flag can be set to True indicating to the NIC that the incoming traffic for that core should be reduced.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 is a block diagram illustrating an example multi-core environment.

FIG. 2 is a block diagram illustrating an example multi-core environment with a saturated and under-utilized core.

FIG. 3 illustrates an example embodiment in accordance with the disclosed embodiments.

FIG. 4 illustrates an example multi-core environment implementing RSS.

FIG. 5 illustrates an example packet header in accordance with embodiments of the present disclosure.

FIG. 6 illustrates an example RSS engine in accordance with embodiments of the present disclosure.

FIG. 7 illustrates an example load balancer in accordance with embodiments of the present disclosure.

FIG. 8 is a flow diagram showing aspects of an example routine components in accordance with embodiments of the present disclosure.

FIG. 9 is a computer architecture diagram illustrating an illustrative computer hardware and software architecture implementing aspects of the techniques and technologies presented herein.

### DETAILED DESCRIPTION

Servers in datacenters typically include a main processor with multiple “cores” that can operate independently, in parallel, or in other suitable ways to execute instructions. To facilitate communications with one another or with external devices, individual servers can also include a network interface controller (NIC) for interfacing with a computer network. A NIC typically includes hardware circuitry and/or firmware configured to enable communications between servers by transmitting/receiving data (e.g., as packets) via a network medium according to Ethernet, Fibre Channel, Wi-Fi, or other suitable physical and/or data link layer standards.

During operation, one or more cores of a processor in a server can cooperate with the NIC to facilitate communications to/from software components executing on the server. Example software components can include virtual machines, applications executing on the virtual machines, a hypervisor for hosting the virtual machines, or other suitable types of components. To facilitate communications to/from the software components, the cores can execute various network processing operations to enforce communications security, perform network virtualization, translate network addresses, maintain a communication flow state, or perform other suitable functions.

One challenge for improving throughput to virtual machines, containers, or applications executing on the virtual machines or containers on a server is that the cores can be overloaded while executing the network processing operations or loads and become communications bottlenecks. Typically, a single core is used for executing network processing loads for a communication flow to maintain a proper communication flow state, e.g., a proper sequence of transmitted packets. As available throughput of the NIC increases, a single core can have inadequate processing capability to execute the network processing loads to accommodate the throughput of the NIC. As such, processing capabilities of the cores can limit transmission rates of network data to/from applications, virtual machines, or other software components executing on the servers. Multiple cores can be implemented to allow for parallel processing of tasks. However, the distribution of tasks to the multiple cores can be challenging.

In order to distribute the incoming traffic across various cores, RSS can be implemented to distribute the packets across various queues where each queue's packet will be picked up by one core. To distribute the packets across various queues and hence the cores, RSS can employ hash algorithms where depending on the RSS configuration, a hash key will contain some parameters from the five tuple (e.g., source and destination addresses, source and destination ports, and the transport layer protocol). While RSS typically assigns packets to queues which are associated with the cores, it should be noted that other mechanisms can be used to assign packets to the cores.

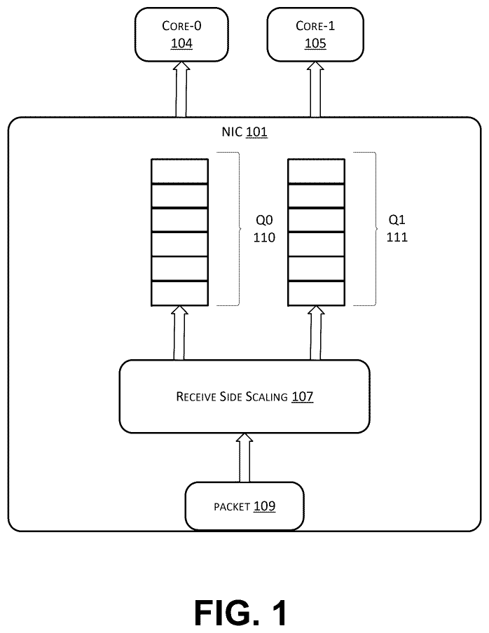

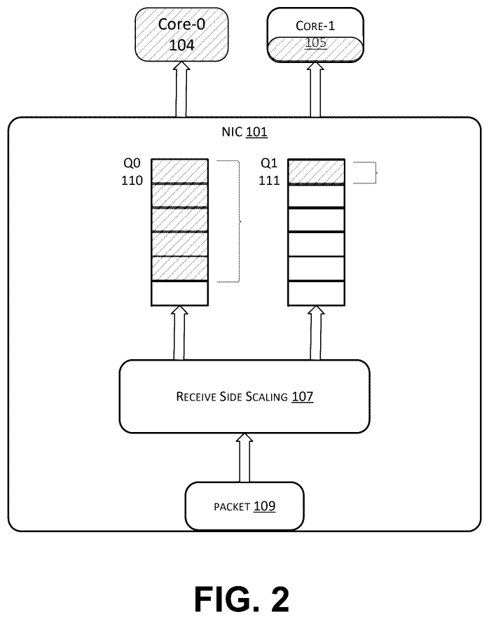

FIG. 1 illustrates an RSS enabled NIC 101 with two RSS queues Q0 110 (pinned to core-0 104) and Q1 111 (pinned to core-1 105). For each packet 109 received by the NIC 101, RSS 107 computes a queue number (either 0 or 1 in this example) using a hashing algorithm to determine which core (0 or 1) the packet 109 should be forwarded to. One issue with this approach is that the incoming traffic can be distributed without information about the CPU usage of the cores. Accordingly, it is possible that the RSS feeds more packets to Q0 110, even though core-0 104 is saturated and where those packets could have been processed by the under-utilized core 1 105. This situation is depicted in FIG. 2, where Core-0 104 is shown as being occupied (saturated) and Core-1 105 is shown as free (not saturated), with the hash marks showing a degree of saturation for the core resources and their associated queues.

Embodiments of the disclosed technology can address certain aspects of the foregoing challenges by an improved RSS technique for load balancing by a NIC operatively coupled to multiple cores. In some embodiments, the NIC can include hardware electronic circuitry or a programmed processing unit configured to provide improved RSS techniques. Examples of such hardware electronic circuitry can include an application-specific integrated circuit (“ASIC”), a field programmable gate array (“FPGA”) with suitable firmware, or other suitable hardware components. A virtual port in a NIC is a virtual network interface corresponding to a hypervisor, a virtual machine, or other components hosted on a server. A virtual port can include one or more virtual channels (e.g., as queues) individually having an assigned core to accommodate network processing load associated with one or more communication flows (e.g., TCP/UDP flows) such as an exchange of data during a communication session between two applications on separate servers.

In various embodiments, a hash table is implemented in the NIC which takes into account the current load on the various cores. In one embodiment, a new flag is introduced in the RSS configuration parameters. One example of a flag can be REDUCE-INCOMING-TRAFFIC-RATE. If the usage of a particular CPU core exceeds a predetermined threshold, the flag can be set to True indicating to the NIC that the incoming traffic for that core should be reduced.

In an embodiment, the hash table index is computed based on the flow five tuple. Each entry in the hash table contains a queue number to which the packets of the flow should be forwarded. The queue number is computed differently in the following two cases:
1) REDUCE-INCOMING-TRAFFIC-RATE is not set: Assume that the flag is not set for both core-0 and core-1. As both cores are under-utilized, the queue number is computed using the approach in the current RSS implementation i.e.:

$$Queue - number = hash - function ( flow - five - tuple ) mod number - of - queues \qquad ( 1 )$$

where mod is a modulo function.
2) REDUCE-INCOMING-TRAFFIC-RATE is set: Assume that core-0 is saturated and core-1 is under-utilized. As core-0 is saturated, it sets the flag REDUCE-INCOMING-TRAFFIC-RATE. In this case, rather than computing the queue number (using equation (1) above), the queue number is always set to 1. This will ensure that the traffic from any new flows will be sent to the under-utilized core, thus allowing for more efficient utilization of the resources. This can also prevent possible packet drops that can occur if packets continue to be sent to core 0. A hash table, an example of which is provided below, is implemented where the first two rows correspond to case-1 above (“REDUCE-INCOMING-TRAFFIC-RATE is not set”) where the queue number is computed using equation (1). The third and fourth row correspond to a new flow for which the queue number is directly set to 1 without any computation (case-2 above—(“2) REDUCE-INCOMING-TRAFFIC-RATE is set”).

| Index | Network Flow Five Tuple | Queue Number |
|---|---|---|
| 1 | (192.168.1.1, 80, 10.0.0.1, 12345, TCP) | 0 (computed using equation (1)) |
| 2 | (192.168.1.2, 443, 10.0.0.2, 12346, UDP) | 1 (computed using equation (1)) |
| 3 | (10.0.0.3, 55555, 192.168.1.1, 80, TCP) | 1 (directly set without any computation) |
| 4 | (192.168.1.3, 443, 10.0.0.3, 12347, UDP) | 1 (directly set without any computation) |

During the time that the flag REDUCE-INCOMING-TRAFFIC-RATE is not reset by core-0, the queue number is set to 1 for new flows. Once the flag is reset, the queue computation for the new flows is using equation (1) above.

In various embodiments, a new configuration parameter is implemented that can take the form of a flag to reduce the rate of incoming traffic rate. A hash table can be implemented in the NIC to enable more efficient load balancing across the various cores. Considering that millions of flows can be active at any given time, the memory used for the hash implementation can be on the order of megabytes which is a small proportion of the memory capacity of NICs which can have a memory capacity on the order of gigabytes.

In the above discussion, the flag REDUCE-INCOMING-TRAFFIC-RATE is set when a core does not have sufficient CPU cycles to process additional packets. More generally, the flag can be set for other resources, such as for constraints on the available memory.

The examples illustrated above are shown with a two-queue system for simplicity. More generally, the illustrated embodiments can be extended to any number of RSS queues. If any core has set the flag to reduce the traffic rate, the queues pinned to this core can be excluded for the computation. In an example, four queues (e.g., q0, q1, q2, and q3) are each pinned to a single core (core0, core1, core2, and core3) respectively. If core2 sets the flag to 1, q2 can be excluded from the computation, and thus there are three queues remaining and the modulus operation (using equation 1) yields the queue-number as 0, 1, or 2, which can be mapped to the queues q0, q1, and q3 respectively.

In some embodiments, in order to further reduce the memory requirements to implement the disclosed techniques, the traffic rate to the saturated cores can be reduced with a reduced hash-table size. The following examples illustrate additional embodiments:
1) REDUCE-INCOMING-TRAFFIC-RATE is not set: Assume that the flag is not set for both core-0 and core-1. As both cores are under-utilized, the queue number will be computed using equation (1) above, but the result is not stored in the hash-table unlike the above described technique. Operations can be continued in the same manner as current RSS implementations. The first two rows in the example table below (note that this is not a hash-table) correspond to this scenario.
2) REDUCE-INCOMING-TRAFFIC-RATE is set: Assume that core-0 is saturated and core-1 is under-utilized. As core-0 is saturated, it sets the flag REDUCE-INCOMING-TRAFFIC-RATE. Once the flag is set, the hash table can be populated. Unlike the case where all the flows in the hash-table are populated, only the TCP flows are populated. As shown in the table below, when a new TCP flow is received (after the REDUCE-INCOMING-TRAFFIC-RATE flag is set for core-0), the new TCP flow is entered in the hash-table with the queue number directly set to 1.

This optimization technique can be implemented for TCP flows. As new TCP flows can be identified by the SYN packet, once the SYN packet is detected, a new entry is created in the hash table for this flow, with the queue-number set to 1.

| | | Is flow present | |
|---|---|---|---|
| Sr No | Network Flow Five Tuple | in hash table | Comments |
| 1 | (192.168.1.1, 80, 10.0.0.1, 12345, TCP) | No | Existing flow before the flag is set |
| 2 | (192.168.1.2, 443, 10.0.0.2, 12346, UDP) | No | Existing flow before the flag is set |
| 3 | (10.0.0.3, 55555, 192.168.1.1, 80, TCP) | Yes | New TCP flow after the flag is set |
| 4 | (192.168.1.3, 443, 10.0.0.3, 12347, UDP) | No | New UDP flow after the flag is set |

Thus, with the above described optimizations, once the flag is set, no new TCP flows are sent to a saturated core, as compared to the above embodiments where neither TCP nor UDP flows are sent to a saturated core after the flag is set. Although this embodiment optimizes the hash table for TCP flows and not for UDP flows, the embodiment nevertheless provides a reduced size for the hash table. The hash table is populated for new TCP flows only after the flag is set. Once the flag is reset, the hash table will not be populated with any new entries, although the hash table will continue to be used as long as flows having entries in the hash-table exist. While there remains at least one entry in the hash-table, the queue-number for any incoming packet is first checked in the hash-table. If no entry exists for the incoming packet, then the queue-number is computed using equation (1) above.

In summary, the following steps are implemented in accordance with the disclosed embodiments:

Before the REDUCE-INCOMING-TRAFFIC-RATE flag is set, the queue number is used per equation (1) above, without writing to the hash table.

Once the REDUCE-INCOMING-TRAFFIC-RATE flag is set, different processes are implemented for TCP and UDP flows as follows:

For UDP flows, the queue number is used per equation (1) above (without writing to the hash table).

For TCP flows, different processes are implemented for new and currently active flows. For currently active flows, as the queue has already been selected, the queue number continues to be used as per equation (1) above, without writing to the hash table. If a new TCP flow is received, which can be identified by the TCP SYN packet, then the new flow is entered in the hash table with the queue-number directly set to 1.

Thus, for any incoming TCP packet (other than the SYN packet in response to which a new entry is entered in the hash table), it is first determined if any entry exists in the hash-table for that flow. If the entry exists, the queue number stored in the hash table is used to direct the packet. Otherwise, the queue number per equation (1) above is used.

With this optimized approach, none of the new TCP flows are sent to the saturated core after the REDUCE-INCOMING-TRAFFIC-RATE flag is set. This helps to reduce the hash-table size substantially while reducing the load on the saturated core.

The above described optimization approach is not applicable for UDP flows. In general, there is no way to know if an incoming UDP packet indicates the start of a new flow as is the case for a new TCP flow based on the SYN packet. In an embodiment, an additional process can be implemented in accordance with the disclosed embodiments for Quick UDP Internet Connection (QUIC) flows, where the start of a QUIC flow can be identified by the “Client Hello” packet. Since QUIC constitutes a significant part of internet traffic, the disclosed optimization techniques can be implemented for a large percentage of UDP traffic.

To summarize the disclosed embodiments, the disclosed efficiency techniques can be implemented using the following operations:
1) Prior to the REDUCE-INCOMING-TRAFFIC-RATE flag being set, continue to use the queue number as per equation (1) above, without writing to the hash table.
2) Once the REDUCE-INCOMING-TRAFFIC-RATE flag is set, follow the appropriate techniques for TCP and UDP flows:

For UDP flows (other than QUIC flows), continue to use the queue number per equation (1) above, without writing to the hash table.

For TCP or QUIC flows, follow the applicable techniques for new and currently active flows. For the currently active flows, as the queue has already been selected, continue to use the queue number as per equation (1) without writing to the hash table. However, if a new TCP or QUIC flow is received, then the new flow is entered in the hash-table with the queue-number directly set to 1.

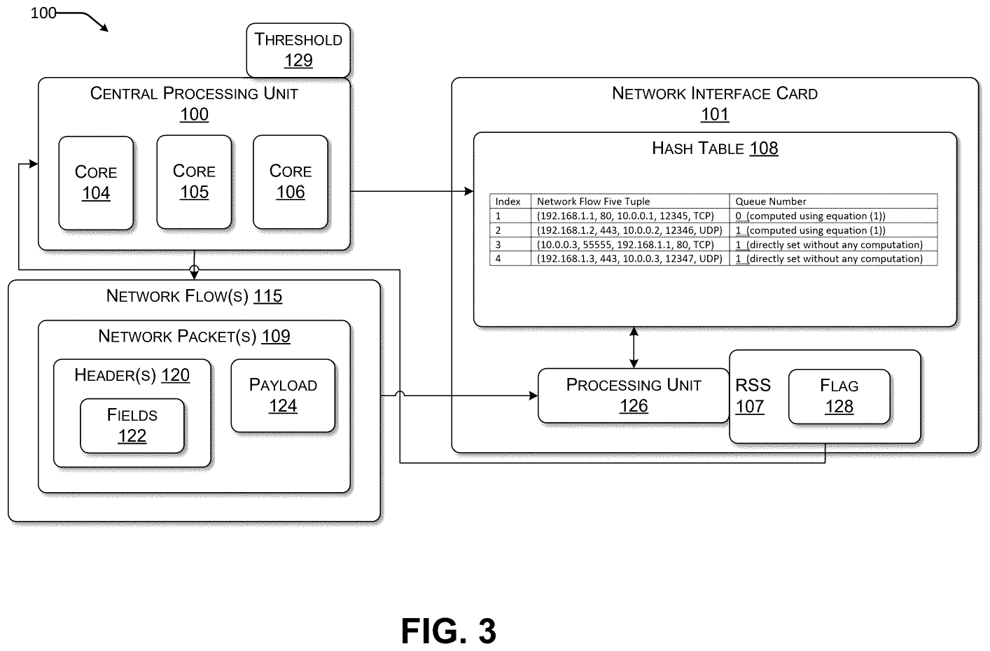

An example embodiment is illustrated in FIG. 3, showing a method for network traffic management in a system comprising a network interface card (NIC) 101 operatively coupled to a processor 126 with multiple cores 104, 105, 106. The NIC 101 is configured to execute receiver side scaling (RSS) 107. The NIC 101 generates a hash table 108 for tracking communications flows 115 that have been assigned to selected cores of the multiple cores 104, 105, 106. In response to receiving, at the NIC 101, a packet 109 associated with a new one of the communication flows 115, the NIC 101 accesses a flag 128 indicating that a first core of the multiple cores 104, 105, 106 exceeds a threshold 129 for CPU utilization. Packet 109 includes header 120, fields 122, and payload 124.

In response to determining that the flag 128 indicates that the first core of the multiple cores 104, 105, 106 exceeds the threshold 129 for CPU utilization, the first core of the multiple cores 104, 105, 106 is excluded from the RSS function 107 for load balancing the multiple cores 104, 105, 106 and a subset of the multiple cores 104, 105, 106 that exclude the first core is used for load balancing the multiple cores 104, 105, 106. Depending on the implementation, queues for a given core can be excluded from the RSS function rather than cores. The RSS function 107 is executed, using the subset, for load balancing the multiple cores 104, 105, 106, to select a second core for processing the packet associated with the new communication flow. The new communication flow is assigned to the second core for processing the new communication flow. The hash table 108 is updated to include the new communication flow and indicate that the new communication flow has been assigned to the second core. The packet 109 associated with the new communication flow is assigned to the second core.

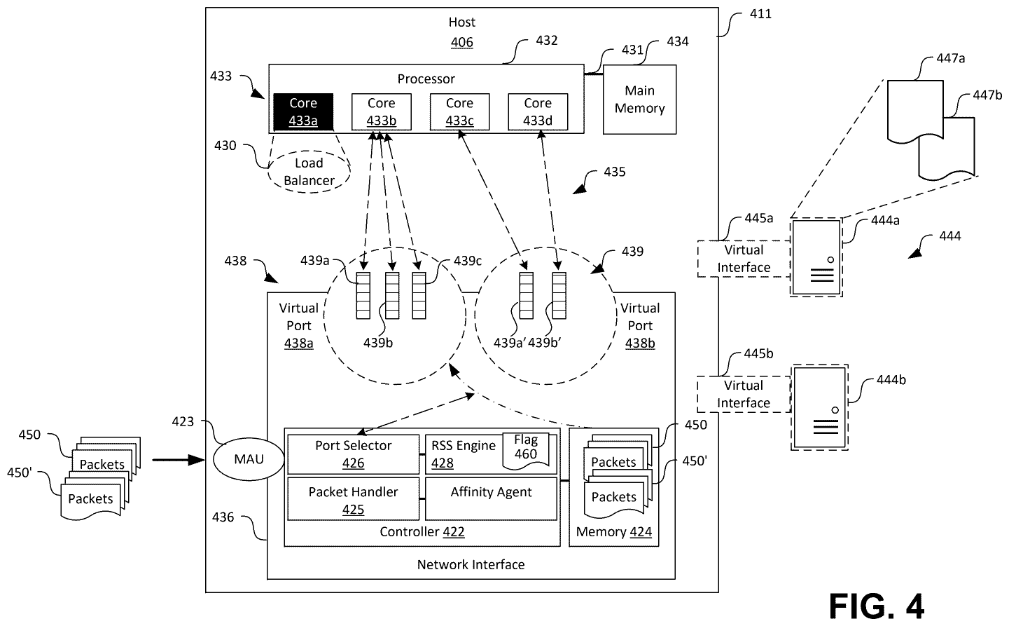

FIG. 4 is a block diagram of a host 406 performing network data processing in accordance with embodiments of the present disclosure. FIG. 4 illustrates distribution of network processing loads to a plurality of core(s) for multiple communication flows. As used herein, a “communication flow” generally refers to a sequence of packets from a source (e.g., an application or a virtual machine executing on a host) to a destination having the same 5-tuple, which can be another application or virtual machine executing on another host, a multicast group, or a broadcast domain. FIG. 4 illustrates the distribution of network processing loads to one or more cores for multiple communication flows. Though particular components of the host 406 are described below, in other embodiments, the host 406 can also include additional and/or different components in lieu of or in additional to those shown in FIG. 4.

In FIG. 4 and in other figures herein, individual software components, objects, classes, modules, and routines may be a computer program, procedure, or process written as source code in C, C++, C#, Java, and/or other suitable programming languages. A component may include, without limitation, one or more modules, objects, classes, routines, properties, processes, threads, executables, libraries, or other components. Components may be in source or binary form. Components may also include aspects of source code before compilation (e.g., classes, properties, procedures, routines), compiled binary units (e.g., libraries, executables), or artifacts instantiated and used at runtime (e.g., objects, processes, threads).

Components within a system may take different forms within the system. As one example, a system comprising a first component, a second component, and a third component. The foregoing components can, without limitation, encompass a system that has the first component being a property in source code, the second component being a binary compiled library, and the third component being a thread created at runtime. The computer program, procedure, or process may be compiled into object, intermediate, or machine code and presented for execution by one or more processors of a personal computer, a tablet computer, a network server, a laptop computer, a smartphone, and/or other suitable computing devices.

Additionally or optionally, components may include hardware circuitry. In certain examples, hardware may be considered fossilized software, and software may be considered liquefied hardware. As just one example, software instructions in a component may be burned to a Programmable Logic Array circuit, or may be designed as a hardware component with appropriate integrated circuits. Equally, hardware may be emulated by software. Various implementations of source, intermediate, and/or object code and associated data may be stored in a computer memory that includes read-only memory, random-access memory, magnetic disk storage media, optical storage media, flash memory devices, and/or other suitable computer readable storage media. As used herein, the term “computer readable storage media” excludes propagated signals.

As shown in FIG. 4, the host 406 can include a motherboard 411 carrying a processor 432, a main memory 434, and a network interface 435 operatively coupled to one another. Though not shown in FIG. 4, in other embodiments, the host 406 can also include a memory controller, a persistent storage, an auxiliary power source, a baseboard management controller operatively coupled to one another. In certain embodiments, the motherboard 411 can include a printed circuit board with one or more sockets configured to receive the foregoing or other suitable components described herein. In other embodiments, the motherboard 411 can also carry indicators (e.g., light emitting diodes), platform controller hubs, complex programmable logic devices, and/or other suitable mechanical and/or electric components in lieu of or in addition to the components shown in FIG. 4.

The processor 432 can be an electronic package containing various components configured to perform arithmetic, logical, control, and/or input/output operations. The processor 432 can be configured to execute instructions to provide suitable computing services, for example, in response to a user request received from the client device. As shown in FIG. 4, the processor 432 can include one or more “cores” 433 configured to execute instructions independently or in other suitable manners. Four cores 433 (illustrated individually as first, second, third, and fourth cores 433a-433d, respectively) are shown in FIG. 4 for illustration purposes. In other embodiments, the processor 432 can include eight, sixteen, or any other suitable number of cores 433. The cores 433 can individually include one or more arithmetic logic units, floating-point units, L1 and L2 cache, and/or other suitable components. Though not shown in FIG. 4, the processor 432 can also include one or more peripheral components configured to facilitate operations of the cores 433. The peripheral components can include, for example, QuickPath® Interconnect controllers, L3 cache, snoop agent pipeline, and/or other suitable elements.

The main memory 434 can include a digital storage circuit directly accessible by the processor 432 via, for example, a data bus 431. In one embodiment, the data bus 431 can include an inter-integrated circuit bus or I²C bus as detailed by NXP Semiconductors N.V. of Eindhoven, the Netherlands. In other embodiments, the data bus 431 can also include a PCIe bus, system management bus, RS-232, small computer system interface bus, or other suitable types of control and/or communications bus. In certain embodiments, the main memory 434 can include one or more DRAM modules. In other embodiments, the main memory 434 can also include magnetic core memory or other suitable types of memory.

As shown in FIG. 4, the processor 432 can cooperate with the main memory 434 to execute suitable instructions to provide one or more virtual machines 444. In FIG. 4, two virtual machines 444 (illustrated as first and second virtual machines 444a and 444b, respectively) are shown for illustration purposes. In other embodiments, the host 406 can be configured to provide one, three, four, or any other suitable number of virtual machines 444. The individual virtual machines 444 can be accessible to the tenants via the overlay and underlay network for executing suitable user operations. For example, as shown in FIG. 4, the first virtual machine 444a can be configured to execute applications 447 (illustrated as first and second applications 447a and 447b, respectively) for one or more of the tenants. In other examples, the individual virtual machines 444 can be configured to execute multiple applications 447.

The individual virtual machines 444 can include a corresponding virtual interface 445 (identified as first virtual interface 445a and second virtual interface 445b) for receiving/transmitting data packets via a virtual network. In certain embodiments, the virtual interfaces 445 can each be a virtualized representation of resources at the network interface 436 (or portions thereof). For example, the virtual interfaces 445 can each include a virtual Ethernet or other suitable types of interface that shares physical resources at the network interface 436. Even though only one virtual interface 445 is shown for each virtual machine 444, in further embodiments, a single virtual machine 444 can include multiple virtual interfaces 445 (not shown).

As shown in FIG. 4, the processor 432 can cooperate with the main memory 434 to execute suitable instructions to provide a load balancer 430. In the illustrated embodiment, the first core 433a is shown as executing and providing the load balancer 430. In other embodiments, other suitable core(s) 433 can also be tasked with executing suitable instructions to provide the load balancer 430. In certain embodiments, the load balancer 430 can be configured to monitor status of network processing loads on the cores 433 and implement the embodiments disclosed herein. In one embodiment, the load balancer 430 can be configured to distribute network processing loads to multiple cores 433.

The network interface 436 can be configured to facilitate virtual machines 444 and/or applications 447 executing on the host 406 to communicate with other components (e.g., other virtual machines 444 on other hosts 406) on virtual networks. In FIG. 4, hardware components are illustrated with solid lines while software components are illustrated in dashed lines. In certain embodiments, the network interface 436 can include one or more NICs. In other embodiments, the network interface 436 can also include port adapters, connectors, or other suitable types of network components in addition to or in lieu of a NIC. Though only one NIC is shown in FIG. 4 as an example of the network interface 436, in further embodiments, the host 406 can include multiple NICs (not shown) of the same or different configurations to be operated in parallel or in other suitable manners.

As shown in FIG. 4, the network interface 436 can include a controller 422, a memory 424, and one or more virtual ports 438 operatively coupled to one another. The controller 422 can include hardware electronic circuitry configured to receive and transmit data, serialize/de-serialize data, and/or perform other suitable functions to facilitate interfacing with other devices on the virtual networks 446. Suitable hardware electronic circuitry suitable for the controller 422 can include a microprocessor, an ASIC, a FPGA, or other suitable hardware components. Example modules for the controller 422 are described in more detail below. The memory 424 can include volatile and/or nonvolatile media (e.g., ROM; RAM, flash memory devices, and/or other suitable storage media) and/or other types of computer-readable storage media configured to store data received from, as well as transmitted to other components on the virtual networks 446.

The virtual ports 438 can be configured to interface with one or more software components executing on the host 406. For example, as shown in FIG. 4, the network interface 436 can include two virtual ports 438 (identified as first and second virtual ports 438a and 438b, respectively) individually configured to interface with the first and second virtual machines 444a and 444b via the first and second virtual interfaces 445a and 445b, respectively. As such, communication flows to the first virtual machine 444a pass through the first virtual port 438a while communication flows to the second virtual machine 444b pass through the second virtual port 438b.

As shown in FIG. 4, each of the virtual ports 438 can include multiple channels or queues 439 individually configured to handle one or more communication flows. In the illustrated embodiment in FIG. 4, the first virtual port 438a includes three queues 439 (identified individually as first, second, and third queues 439a-439c, respectively). The second virtual port 438b includes two queues 439 (identified individually as first and second queues 439a′ and 439b′, respectively). In other embodiments, the first and/or second virtual ports 438 can include four, five, six, or any other suitable number of queues 439.

As shown in FIG. 4, the controller 422 can include a media access unit (“MAU”) 423, a packet handler 425, a port selector 426, and a RSS engine 428 operatively coupled to one another. Though particular components are shown in FIG. 4, in other embodiments, the controller 422 can also include direct memory access interface and/or other suitable components. The MAU 423 can be configured to interface with a transmission medium of the underlay network to receive and/or transmit data, for example, as packets 450 having a header, a payload, and optionally a trailer. In one embodiment, the MAU 423 can include an Ethernet transceiver. In other embodiments, the MAU 423 can also include a fiber optic transceiver or other suitable types of media interfacing components.

The packet handler 425 can be configured to facilitate operations related to receiving and transmission of packets 450. For example, in certain embodiments, the packet handler 425 can include a receive de-serializer, a CRC generator/checker, a transmit serializer, an address recognition module, a first-in-first-out control module, and a protocol control module. In other embodiments, the packet handler 425 can also include other suitable modules in addition to or in lieu of the foregoing modules. As described in more detail below, the packet handler 425 can also cooperate with the port selector 426 and the RSS engine 428 to process and forward packets 450 to the virtual machines 444 and/or the application 447.

In an embodiment, the RSS engine 428 can be configured to distribute the incoming packets 450 and 450′ assigned to a virtual port 438 to a particular queue 439 in the virtual port 438 based on a particular destination of the packets 450 and 450′ (e.g., the application 447 executing on the virtual machine 444). For example, the RSS engine 428 can be configured to calculate a hash value (e.g., 32 bits) based on a source IP address, a destination IP address, a source port, a destination port, and/or other suitable Transmission Control Protocol (“TCP”) parameters (referred to as “characteristic of communication”) included in the headers of the packets 450 and 450′.

Upon identifying the particular destination, the RSS engine 428 can then assign the packets 450 and 450′ to one or more queues 439 in the virtual port 438 based on one or more bits of the calculated hash value by consulting an indirection table associated with the virtual port 438.

During operation, the second core 433b can be overloaded with execution of network processing loads for processing the packets 450 and 450′ from both the second and third queues 439b and 439c. For example, the second core 433b can have a utilization percentage that exceeds a high threshold. Under such operating conditions, the second core 433b can become a communication bottleneck for processing packets 450 and 450′ in the second and third queues 439b and 439c.

In accordance with embodiments of the disclosed technology, such conditions can be monitored such as utilization percentage and/or other operating parameters of the individual cores 433, for example, via a debug port on the uncore or other suitable interfaces of the processor 432. In other embodiments, a notification can be provided by the processor 432. The notification can indicate that a utilization percentage of the second core 433b exceeds a threshold 464 and a current value of the utilization percentage. In further embodiments, operating parameters of the cores 433 can be monitored using other suitable methods.

Based on the information, an overall utilization can be calculated for each core 433, a total time spent in executing network processing loads for each queue 439, a total number of packets processed for each queue 439, and/or other suitable operating values. Using such received and/or calculated operating parameters/values, it can be determined whether any of the cores 433 is overloaded and thus susceptible to becoming a communication bottleneck. As such, a flag 460 can be set to indicate that a core of the cores 433 has reach the threshold 464.

Several embodiments of the disclosed technology can improve network data throughput to applications 447, virtual machines 444, or other software components on a host 406 when compared to other communication techniques. In certain computing systems, RSS operations can be implemented as a software component, for example, a module of an operating system executed by a core on the server.

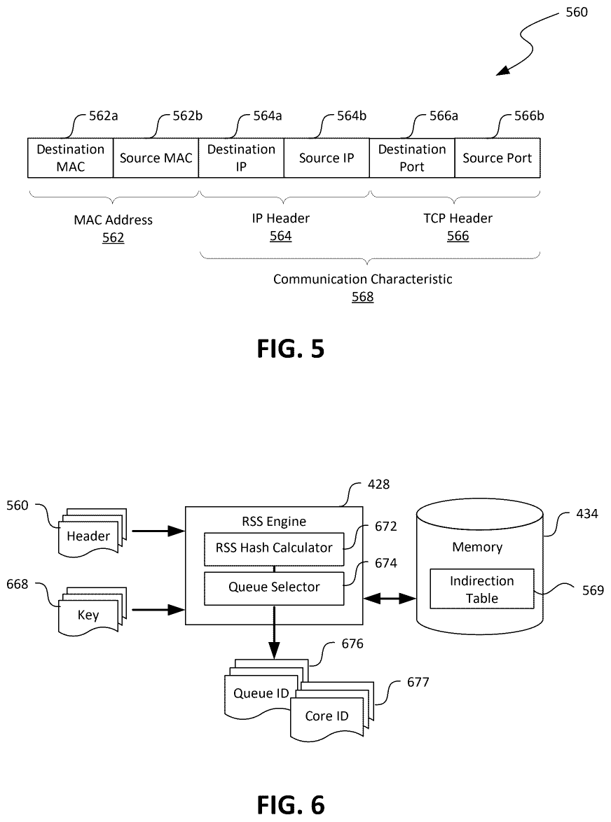

FIG. 5 is an example data schema suitable for a header 560 of a packet in accordance with embodiments of the present technology. In addition to the header 560, the packet can also include a payload and a trailer (not shown). As shown in FIG. 4, the header 560 can include MAC addresses 562 (i.e., destination MAC 562a and source MAC 562b), an IP header 564 (i.e., destination IP address 564a and source IP address 564b), and a TCP header 566 (i.e., destination port 566a and source port 566b). In certain embodiments, the combination of the IP header 564 and the TCP header 566 is referred to as a characteristic of communication 568 of a packet associated with the header 560. In other embodiments, other header fields (not shown) can also be a part of the characteristic of communication 568 in addition to or in lieu of the IP header 564 and the TCP header 566.

FIG. 6 is a block diagram showing example hardware modules suitable for the RSS engine 428 in accordance with embodiments of the present technology. As shown in FIG. 6, the RSS engine 428 can include a RSS hash calculator 672 and a queue selector 674 operatively coupled to one another. The RSS hash calculator 672 can be configured to calculate a hash value based on a characteristic of communication 568 of the header 560 and a key 668. The key 668 can include a random number or other suitable number unique to the RSS engine 428. Various hash heuristics can be used for calculating the hash value. Example hash heuristics can include perfect hashing, minimal perfect hashing, hashing variable length data, or other suitable hashing functions. The RSS hash calculator 672 can then forward the calculated hash vale to the queue selector 674 for further processing. The queue selector 674 can be configured to identify a queue in a virtual port based on the calculated hash value or a portion thereof. For example, the queue selector 674 can compare two least significant bits of a calculated hash value to those included in an indirection table 569 and identify a corresponding queue/core ID 676 and 677. In other examples, the queue selector 674 can also use the hash value or a portion thereof as the queue/core ID or identify the queue/core ID in other suitable manners.

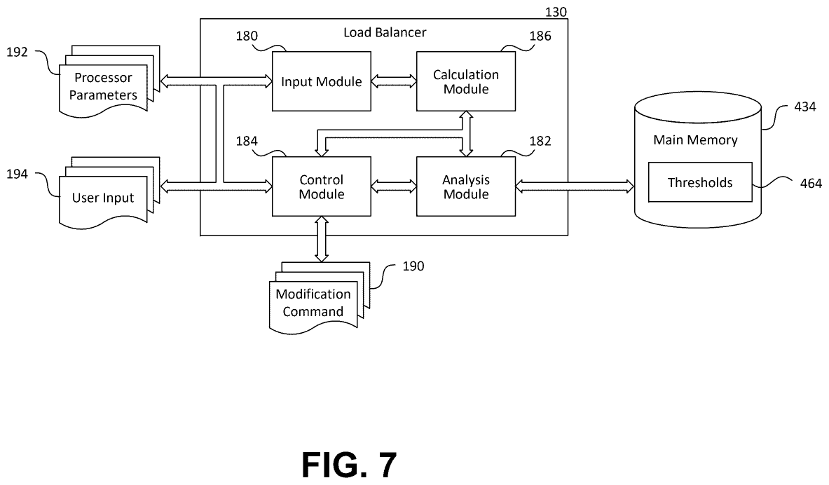

FIG. 7 is a block diagram showing certain computing modules suitable for the load balancer 130 in accordance with embodiments of the disclosed technology. As shown in FIG. 7, the load balancer 130 includes an input module 180, a calculation module 186, a control module 184, and an analysis module 182 interconnected with one another. The input module 180 can be configured to receive processor parameters 192 by accessing debug information from the processor or via a debug port and via other suitable interfaces. The processor parameters 192 can include core utilization percentage, core active time, core execution task identification, or others suitable parameters. The input module 180 can also be configured to receive user input 194 such as a high threshold, a low threshold, or other suitable information from an administrator, a user, or other suitable entities. The input module 180 can then provide the received processor parameters 192 and the user input 194 to the analysis module 182 for further processing.

The calculation module 186 can include routines configured to perform various types of calculations to facilitate operation of other components of the load balancer 130. For example, the calculation module 186 can include routines for accumulating a total time and a total number of packets a core is used for executing network processing loads of individual queues. In another example, the calculation module 186 can be configured to calculate an overall utilization of each of the cores 133. In other examples, the calculation module 186 can include linear regression, polynomial regression, interpolation, extrapolation, and/or other suitable subroutines. In further examples, the calculation module 186 can also include counters, timers, and/or other suitable routines.

The analysis module 182 can be configured to analyze the various received and/or calculated processor parameters to determine whether a utilization level of a core is higher than a high threshold or lower than a low threshold. For example, the analysis module 182 can compare a utilization percentage of a core to the high threshold and to the low threshold. The analysis module 182 can then indicate whether the core is likely overloaded or underutilized according to results of analysis. The control module 184 can be configured to control issuance of modification commands 190 according to the analysis results from the analysis module 182. In certain embodiments, the control module 184 can be configured to issue a flag. In other embodiments, the control module 184 can be configured to coalesce network processing loads from multiple cores to one or a reduced number of cores.

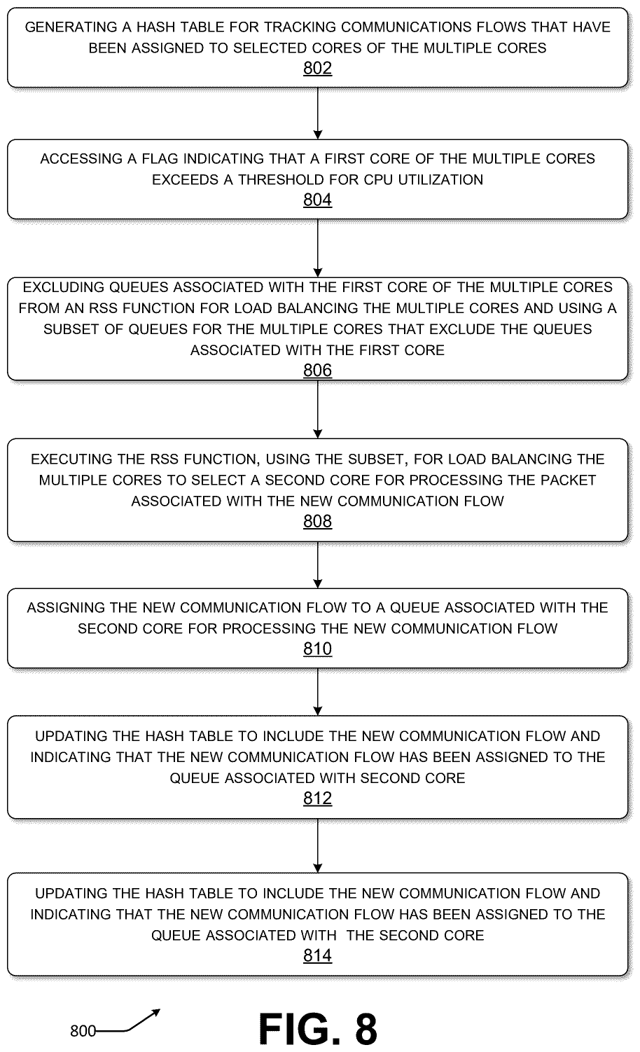

Turning now to FIG. 8, aspects of a process 800 for network traffic management in a system comprising a network interface card (NIC) operatively coupled to a processor with multiple cores is shown and described. With respect to FIG. 8, the process 800 includes operation 802 illustrating generating, by the NIC, a hash table for tracking communications flows that have been assigned to selected cores of the multiple cores.

Operation 804 illustrates in response to receiving, at the NIC, a packet associated with a new communication flow, accessing, by the NIC, a flag indicating that a first core of the multiple cores exceeds a threshold for CPU utilization.

Operation 806 illustrates in response to determining that the flag indicates that the first core of the multiple cores exceeds the threshold for CPU utilization, excluding queues associated with the first core of the multiple cores from an RSS function for load balancing the multiple cores and using a subset of queues for the multiple cores that exclude the queues associated with first core for load balancing the multiple cores.

Operation 808 illustrates executing the RSS function, using the subset, for load balancing the multiple cores to select a second core for processing the packet associated with the new communication flow.

Operation 810 illustrates assigning the new communication flow to a queue associated with the second core for processing the new communication flow.

Operation 812 illustrates updating the hash table to include the new communication flow and indicating that the new communication flow has been assigned to the queue associated with the second core.

Operation 814 illustrates sending the packet associated with the new communication flow to the queue associated with second core.

For ease of understanding, the process discussed in this disclosure is delineated as separate operations represented as independent blocks. However, these separately delineated operations should not be construed as necessarily order dependent in their performance. The order in which the process is described is not intended to be construed as a limitation, and any number of the described process blocks may be combined in any order to implement the process or an alternate process. Moreover, it is also possible that one or more of the provided operations is modified or omitted.

The particular implementation of the technologies disclosed herein is a matter of choice dependent on the performance and other requirements of a computing device. Accordingly, the logical operations described herein are referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated methods can end at any time and need not be performed in their entireties. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the process 800 can be implemented, at least in part, by modules running the features disclosed herein which can be a dynamically linked library (DLL), a statically linked library, functionality produced by an application programing interface (API), a compiled program, an interpreted program, a script, or any other executable set of instructions. Data can be stored in a data structure in one or more memory components. Data can be retrieved from the data structure by addressing links or references to the data structure.

Although the illustration may refer to the components of the figures, it should be appreciated that the operations of the process 800 may also be implemented in other ways. In addition, one or more of the operations of the process 800 may alternatively or additionally be implemented, at least in part, by a chipset working alone or in conjunction with other software modules. In the example described below, one or more modules of a computing system can receive and/or process the data disclosed herein. Any service, circuit, or application suitable for providing the techniques disclosed herein can be used in operations described herein.

Computer-readable media includes computer-readable storage media and/or communication media. Computer-readable storage media includes one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including RAM, static RAM (SRAM), dynamic RAM (DRAM), phase change memory (PCM), ROM, erasable programmable ROM (EPROM), electrically EPROM (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer-readable storage media, communication media can embody computer-readable instructions, data structures, program modules, or other data in a modulated data signal, such as a carrier wave, or other transmission mechanism. As defined herein, computer storage media does not include communication media. That is, computer-readable storage media does not include communications media consisting solely of a modulated data signal, a carrier wave, or a propagated signal, per se.

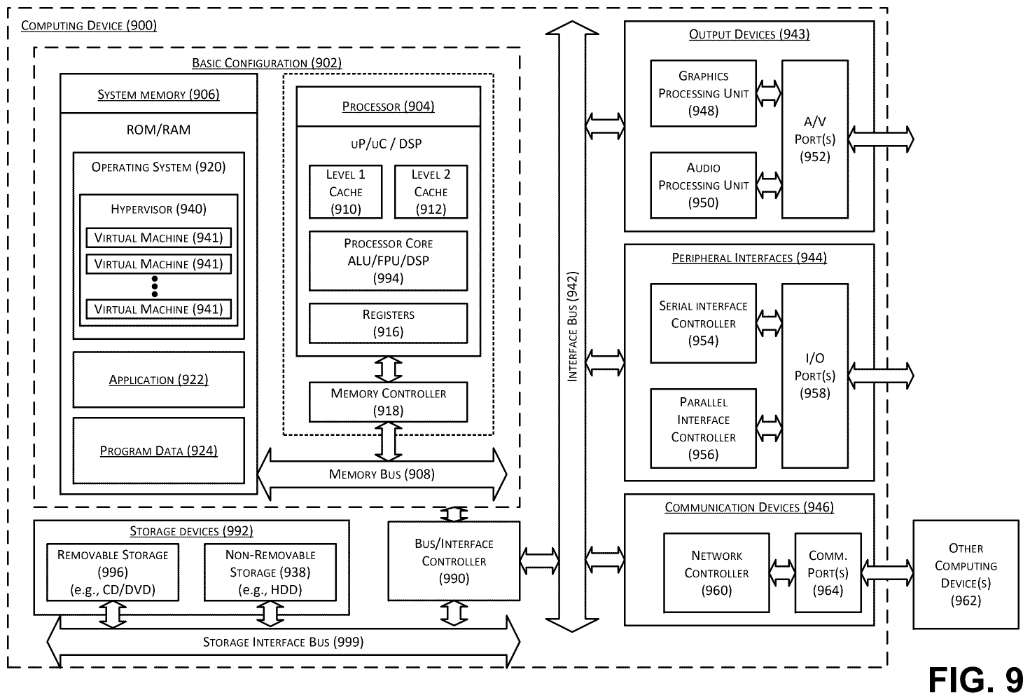

FIG. 9 is a computing device 900 suitable for certain components of the computing system 100 in FIG. 1. In a very basic configuration 902, the computing device 900 can include one or more processors 904 and a system memory 906. A memory bus 908 can be used for communicating between processor 904 and system memory 906. Depending on the desired configuration, the processor 904 can be of any type including but not limited to a microprocessor (μP), a microcontroller (μC), a digital signal processor (DSP), or any combination thereof. The processor 904 can include one more levels of caching, such as a level-one cache 910 and a level-two cache 912, a processor core 994, and registers 916. An example processor core 994 can include an arithmetic logic unit (ALU), a floating point unit (FPU), a digital signal processing core (DSP Core), or any combination thereof. An example memory controller 918 can also be used with processor 904, or in some implementations memory controller 918 can be an internal part of processor 904.

Depending on the desired configuration, the system memory 906 can be of any type including but not limited to volatile memory (such as RAM), non-volatile memory (such as ROM, flash memory, etc.) or any combination thereof. The system memory 906 can include an operating system 920, one or more applications 922, and program data 924. As shown in FIG. 8, the operating system 920 can include a hypervisor 940 for managing one or more virtual machines 941. This described basic configuration 902 is illustrated in FIG. 8 by those components within the inner dashed line.

The computing device 900 can have additional features or functionality, and additional interfaces to facilitate communications between basic configuration 902 and any other devices and interfaces. For example, a bus/interface controller 990 can be used to facilitate communications between the basic configuration 902 and one or more data storage devices 992 via a storage interface bus 999. The data storage devices 992 can be removable storage devices 996, non-removable storage devices 938, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media can include volatile and nonvolatile, removable and non-removable media implemented in any method or technology for storage of information, such as computer readable instructions, data structures, program modules, or other data. The term “computer readable storage media” or “computer readable storage device” excludes propagated signals and communication media.

The system memory 906, removable storage devices 996, and non-removable storage devices 938 are examples of computer readable storage media. Computer readable storage media include, but not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other media which can be used to store the desired information and which can be accessed by computing device 900. Any such computer readable storage media can be a part of computing device 900. The term “computer readable storage medium” excludes propagated signals and communication media.

The computing device 900 can also include an interface bus 942 for facilitating communication from various interface devices (e.g., output devices 943, peripheral interfaces 944, and communication devices 946) to the basic configuration 902 via bus/interface controller 990. Example output devices 943 include a graphics processing unit 948 and an audio processing unit 950, which can be configured to communicate to various external devices such as a display or speakers via one or more A/V ports 952. Example peripheral interfaces 944 include a serial interface controller 954 or a parallel interface controller 956, which can be configured to communicate with external devices such as input devices (e.g., keyboard, mouse, pen, voice input device, touch input device, etc.) or other peripheral devices (e.g., printer, scanner, etc.) via one or more I/O ports 958. An example communication device 946 includes a network controller 960, which can be arranged to facilitate communications with one or more other computing devices 962 over a network communication link via one or more communication ports 964.

The network communication link can be one example of a communication media. Communication media can typically be embodied by computer readable instructions, data structures, program modules, or other data in a modulated data signal, such as a carrier wave or other transport mechanism, and can include any information delivery media. A “modulated data signal” can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), microwave, infrared (IR) and other wireless media. The term computer readable media as used herein can include both storage media and communication media.

The computing device 900 can be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. The computing device 900 can also be implemented as a personal computer including both laptop computer and non-laptop computer configurations.

The disclosure presented herein also encompasses the subject matter set forth in the following clauses.
Clause 1: A method for network traffic management in a system comprising a network interface card (NIC) operatively coupled to a processor with multiple cores, the NIC configured to execute receiver side scaling (RSS), the method comprising:
generating, by the NIC, a hash table for tracking communications flows that have been assigned to selected cores of the multiple cores;
in response to receiving, at the NIC, a packet associated with a new communication flow, accessing, by the NIC, a flag indicating that a first core of the multiple cores exceeds a threshold for CPU utilization;
in response to determining that the flag indicates that the first core of the multiple cores exceeds the threshold for CPU utilization, excluding queues associated with the first core of the multiple cores from an RSS function for load balancing the multiple cores and using a subset of queues for the multiple cores that exclude the queues associated with first core for load balancing the multiple cores;
executing the RSS function, using the subset, for load balancing the multiple cores to select a second core for processing the packet associated with the new communication flow;
assigning the new communication flow to a queue associated with the second core for processing the new communication flow;
updating the hash table to include the new communication flow and indicating that the new communication flow has been assigned to the queue associated with the second core; and
sending the packet associated with the new communication flow to the queue associated with second core.
Clause 2: The method of clause 1, wherein the hash table is indexed based on a five tuple of communications flow packets.
Clause 3: The method of any of clauses 1-2, wherein the RSS function comprises a modulo function based on a total number of available cores of the multiple cores or a total number of available queues.
Clause 4: The method of any of clauses 1-3, wherein the hash table is not populated when no flags indicate that any of the multiple cores exceed the threshold.
Clause 5: The method of any of clauses 1-4, wherein the hash table is only populated for TCP flows.
Clause 6: The method of any of clauses 1-5, wherein the hash table is only populated for TCP flows and UDP flows that are QUIC flows.
Clause 7: The method of clauses 1-6, wherein the hash table comprises an index to each entry, a five tuple for each flow in the hash table, and a queue number associated with one of the multiple cores.
Clause 8: A system for network traffic management in a system comprising a network interface card (NIC) operatively coupled to a processing system with multiple cores, the NIC configured to execute receiver side scaling (RSS), the system comprising:
the NIC
the processing system; and
a computer-readable medium having encoded thereon computer-readable instructions that when executed by the processing system, cause the system to perform operations comprising:
generating, by the NIC, a hash table for tracking communications flows that have been assigned to selected cores of the multiple cores;
in response to receiving, at the NIC, a packet associated with a new communication flow, accessing, by the NIC, a flag indicating that a first core of the multiple cores exceeds a threshold for CPU utilization;
in response to determining that the flag indicates that the first core of the multiple cores exceeds the threshold for CPU utilization, excluding the first core of the multiple cores from an RSS function for load balancing the multiple cores and using a subset of the multiple cores that exclude the first core for load balancing the multiple cores;
executing the RSS function, using the subset, for load balancing the multiple cores to select a second core for processing the packet associated with the new communication flow;
assigning the new communication flow to the second core for processing the new communication flow;
updating the hash table to include the new communication flow and indicating that the new communication flow has been assigned to the second core; and
sending the packet associated with the new communication flow to the second core.
Clause 9: The computing system of clause 8, wherein the hash table is indexed based on a five tuple of communications flow packets.
Clause 10: The computing system of any of clauses 8 and 9, wherein the RSS function comprises a modulo function based on a total number of available cores of the multiple cores.
Clause 11: The computing system of any of clauses 8-10, wherein the hash table is not populated when there are no flags indicating that any of the multiple cores exceed the threshold.
Clause 12: The computing system of any of clauses 8-11, wherein the hash table is only populated for TCP flows.
Clause 13: The computing system of any of clauses 8-12, wherein the hash table is only populated for TCP flows and UDP flows that are QUIC flows.
Clause 14: The computing system of any of clauses 8-13, wherein the hash table comprises an index to each entry, a five tuple for each flow in the hash table, and a queue number associated with one of the multiple cores.
Clause 15: A computer-readable storage medium having encoded thereon computer-readable instructions that when executed by a system, cause the system to perform operations comprising:
generating, by a NIC operatively coupled to a processor with multiple cores, the NIC configured to execute receiver side scaling (RSS), a hash table for tracking communications flows that have been assigned to selected cores of the multiple cores;
generating, by the NIC, a hash table for tracking communications flows that have been assigned to selected cores of the multiple cores;
in response to receiving, at the NIC, a packet associated with a new communication flow, accessing, by the NIC, a flag indicating that a first core of the multiple cores exceeds a threshold for CPU utilization;
in response to determining that the flag indicates that the first core of the multiple cores exceeds the threshold for CPU utilization, excluding the first core of the multiple cores from an RSS function for load balancing the multiple cores and using a subset of the multiple cores that exclude the first core for load balancing the multiple cores;
executing the RSS function, using the subset, for load balancing the multiple cores to select a second core for processing the packet associated with the new communication flow;
assigning the new communication flow to the second core for processing the new communication flow;
updating the hash table to include the new communication flow and indicating that the new communication flow has been assigned to the second core; and
sending the packet associated with the new communication flow to the second core.
Clause 16: The computer-readable storage medium of clause 15, wherein the hash table is indexed based on a five tuple of communications flow packets.
Clause 17: The computer-readable storage medium of any of clauses 15 and 16, wherein the RSS function comprises a modulo function based on a total number of available cores of the multiple cores.
Clause 18: The computer-readable storage medium of any of clauses 15-17, wherein the hash table is not populated when there are no flags indicating that any of the multiple cores exceed the threshold.
Clause 19: The computer-readable storage medium of any of clauses 15-18, wherein the hash table is only populated for TCP flows.
Clause 20: The computer-readable storage medium of any of the clauses 15-19, wherein the hash table is only populated for TCP flows and UDP flows that are QUIC flows.

Conditional language such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

The terms “a,” “an,” “the” and similar referents used in the context of describing the invention (especially in the context of the following claims) are to be construed to cover both the singular and the plural unless otherwise indicated herein or clearly contradicted by context. The terms “based on,” “based upon,” and similar referents are to be construed as meaning “based at least in part” which includes being “based in part” and “based in whole” unless otherwise indicated or clearly contradicted by context.

In addition, any reference to “first,” “second,” etc. elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element (e.g., two different network packets).

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

1. A method for network traffic management in a system comprising a network interface card (NIC) operatively coupled to a processor with multiple cores, the NIC configured to execute receiver side scaling (RSS), the method comprising:
generating, by the NIC, a hash table for tracking communications flows that have been assigned to selected cores of the multiple cores;
in response to receiving, at the NIC, a packet associated with a new communication flow, accessing, by the NIC, a flag indicating that a first core of the multiple cores exceeds a threshold for CPU utilization;
in response to determining that the flag indicates that the first core of the multiple cores exceeds the threshold for CPU utilization, excluding queues associated with the first core of the multiple cores from an RSS function for load balancing the multiple cores and using a subset of queues for the multiple cores that exclude the queues associated with first core for load balancing the multiple cores;
executing the RSS function, using the subset, for load balancing the multiple cores to select a second core for processing the packet associated with the new communication flow;
assigning the new communication flow to a queue associated with the second core for processing the new communication flow;
updating the hash table to include the new communication flow and indicating that the new communication flow has been assigned to the queue associated with the second core; and
sending the packet associated with the new communication flow to the queue associated with second core.

2. The method of claim 1, wherein the hash table is indexed based on a five tuple of communications flow packets.

3. The method of claim 1, wherein the RSS function comprises a modulo function based on a total number of available cores of the multiple cores or a total number of available queues.

4. The method of claim 1, wherein the hash table is not populated when no flags indicate that any of the multiple cores exceed the threshold.

5. The method of claim 1, wherein the hash table is only populated for TCP flows.

6. The method of claim 1, wherein the hash table is only populated for TCP flows and UDP flows that are QUIC flows.

7. The method of claim 1, wherein the hash table comprises an index to each entry, a five tuple for each flow in the hash table, and a queue number associated with one of the multiple cores.

8. A system for network traffic management in a system comprising a network interface card (NIC) operatively coupled to a processing system with multiple cores, the NIC configured to execute receiver side scaling (RSS), the system comprising:
the NIC
the processing system; and
a computer-readable medium having encoded thereon computer-readable instructions that when executed by the processing system, cause the system to perform operations comprising:
generating, by the NIC, a hash table for tracking communications flows that have been assigned to selected cores of the multiple cores;
in response to receiving, at the NIC, a packet associated with a new communication flow, accessing, by the NIC, a flag indicating that a first core of the multiple cores exceeds a threshold for CPU utilization;
in response to determining that the flag indicates that the first core of the multiple cores exceeds the threshold for CPU utilization, excluding the first core of the multiple cores from an RSS function for load balancing the multiple cores and using a subset of the multiple cores that exclude the first core for load balancing the multiple cores;
executing the RSS function, using the subset, for load balancing the multiple cores to select a second core for processing the packet associated with the new communication flow;
assigning the new communication flow to the second core for processing the new communication flow;
updating the hash table to include the new communication flow and indicating that the new communication flow has been assigned to the second core; and
sending the packet associated with the new communication flow to the second core.

9. The system of claim 8, wherein the hash table is indexed based on a five tuple of communications flow packets.

10. The system of claim 8, wherein the RSS function comprises a modulo function based on a total number of available cores of the multiple cores.

11. The system of claim 8, wherein the hash table is not populated when there are no flags indicating that any of the multiple cores exceed the threshold.

12. The system of claim 8, wherein the hash table is only populated for TCP flows.

13. The system of claim 8, wherein the hash table is only populated for TCP flows and UDP flows that are QUIC flows.

14. The system of claim 8, wherein the hash table comprises an index to each entry, a five tuple for each flow in the hash table, and a queue number associated with one of the multiple cores.

15. A computer-readable storage medium having encoded thereon computer-readable instructions that when executed by a system, cause the system to perform operations comprising:
generating, by a NIC operatively coupled to a processor with multiple cores, the NIC configured to execute receiver side scaling (RSS), a hash table for tracking communications flows that have been assigned to selected cores of the multiple cores;
generating, by the NIC, a hash table for tracking communications flows that have been assigned to selected cores of the multiple cores;
in response to receiving, at the NIC, a packet associated with a new communication flow, accessing, by the NIC, a flag indicating that a first core of the multiple cores exceeds a threshold for CPU utilization;
in response to determining that the flag indicates that the first core of the multiple cores exceeds the threshold for CPU utilization, excluding the first core of the multiple cores from an RSS function for load balancing the multiple cores and using a subset of the multiple cores that exclude the first core for load balancing the multiple cores;
executing the RSS function, using the subset, for load balancing the multiple cores to select a second core for processing the packet associated with the new communication flow;
assigning the new communication flow to the second core for processing the new communication flow;
updating the hash table to include the new communication flow and indicating that the new communication flow has been assigned to the second core; and
sending the packet associated with the new communication flow to the second core.

16. The computer-readable storage medium of claim 15, wherein the hash table is indexed based on a five tuple of communications flow packets.

17. The computer-readable storage medium of claim 15, wherein the RSS function comprises a modulo function based on a total number of available cores of the multiple cores.

18. The computer-readable storage medium of claim 15, wherein the hash table is not populated when there are no flags indicating that any of the multiple cores exceed the threshold.

19. The computer-readable storage medium of claim 15, wherein the hash table is only populated for TCP flows.

20. The computer-readable storage medium of claim 15, wherein the hash table is only populated for TCP flows and UDP flows that are QUIC flows.
